(19) United States
(12) Patent Application Publication
(10) Pub. No.: US 2021/0380446 A1
(43) Pub. Date: Dec. 9, 2021

(54) TREATMENT OF LANDFILL LEACHATE AND OTHER ENVIRONMENTAL WATER WASTE STREAMS

(71) Applicant: PSMG, LLC., Milton, GA (US)

(72) Inventor: Jason K. Holt, Ball Ground, GA (US)

(21) Appl. No.: 17/337,010

(22) Filed: Jun. 2, 2021

Related U.S. Application Data
(60) Provisional application No. 63/033,962, filed on Jun. 3, 2020.

(51) Int. Cl. C02F 1/56

(52) U.S. Cl. CPC C02F 1/56; C02F 2101/345

(57) ABSTRACT

High molecular weight polyethylene oxide polymer flocculants are found to be effective for removal of dissolved phenols from wastewater flow, which can especially useful for cleanup of landfill leachate and industrial wastewater sources. Also, the treatment of wastewater from various landfill environments can be treated with polyethylene glycol flocculants with a cofactor. Suitable treatment systems and processing are described.

### CROSS REFERENCE TO RELATED APPLICATIONS

This reference claims priority to copending U.S. provisional patent application 63/033,962 filed on Jun. 3, 2020 to Holt, entitled “Flocculation of Per- and Polyfluoronated Organic Waste With Polyethylene Oxide Polymers With an Initiator Compound,” incorporated herein by reference.

### BACKGROUND OF THE INVENTION

Awareness of environmental hazards from chemicals that enter the water supply of municipalities is growing due to broad media reports of serious contamination events. The identification of a cost effective method for controlling spread of contaminants into water supplies and the general environment can provide important relief.

Aromatic organic compounds, such as phenols, and per- and polyfluoroalkyl substances, i.e., per- and polyfluoro organic compositions, can be present waste streams and landfill leachates due to the use of these compositions in a range of products. These compositions do not naturally degrade, and they find their way into water supplies. These compounds are associated with various health risks. Removal of these compositions has historically been difficult, and they are generally present in low concentrations that are nevertheless potentially harmful.

### SUMMARY OF THE INVENTION

In a first aspect, the invention pertains to a method for the removal of contaminants from wastewater effluents, the method comprising:

adding polyethylene oxide to landfill leachate to form flocs, wherein the polyethylene oxide has an average molecular weight of at least 500,000 g/mole; and

separating the flocculated solids from the leachate solution to reduce contaminants from the leachate stream to form a treated water stream.

In some embodiments, the phenolic compounds in the treated water stream are no more than about 0.5 times the amount of phenolic compounds in the leachate. In additional or alternative embodiments, wherein the amount of zinc in the treated waste stream is no more than about 75% of the amount of zinc in the leachate.

In a further aspect, the invention pertains to a system for purification of landfill leachate comprising:

a landfill comprising a runoff collection system comprising a leachate drainage conduit;

a separation system;

a polyethylene oxide (PEO) delivery system comprising a PEO reservoir and an outflow conduit;

an inflow channel configured to deliver landfill leachate to the separation system; and

an outflow to allow purified water to exit from the separation system, wherein the outflow conduit of the PEO delivery system is configured to add PEO to the leachate stream prior to introduction into the separation system.

In another aspect, the invention pertains to a method for removal of phenols from wastewater, the method comprising the step of adding polyethylene oxide to wastewater that has been determined to have an undesirably high phenol contaminant level, wherein the polyethylene oxide has an average molecular weight of at least 500,000 g/mole and wherein the polyethylene oxide forms flocs sequestering the phenol that is reduced to levels in the water to no more than 500 μg/liter.

In other aspects, the invention pertains to a method for performing the removal of unwanted solids and organics from leachate or runoff treatment streams comprising the introduction of a non-ionic water soluble polymer with an average molecular weight of between 500,000 and 22 million and subsequently followed by an aromatic polymer or a phenolic solution to induce flocculation.

### BRIEF DESCRIPTION OF THE DRAWINGS

FIG. 1 is a schematic diagram of a flocculation based water treatment system for landfill leachate.

### DETAILED DESCRIPTION OF THE INVENTION

While landfill leachates and other wastewater effluents can be complex chemical mixtures, the use of non-ionic polymer flocculants, such as polyethylene oxide flocculants, have been found to be effective in removing both moderate amounts of suspended solids and dissolved organic compounds, including phenols. Extrapolating these results, it is anticipated that the processing can also be effective to remove per- and polyfluoroalkyl substances, i.e., per- and polyfluoro organic compositions, which can be present waste streams and landfill leachates due to the use of these compositions in a range of products. Fluorinated phenols have been documented that they have been removed effectively using the flocculating processes described herein. For example, 2-fluorophenol is water soluble, but is effectively removed by flocculation using the processes described herein. Some of these organic compositions do not naturally degrade, and they find their way into water supplies. Some of the relevant organic compounds can be associated with various health risks. Removal of these composition has historically been difficult or expensive. The flocculation with non-ionic flocculants, especially polyethylene oxide, provides a relative low cost, low capital investment pre-treatment approach for the treatment of waste water from challenging sources, such as land fill leachates, coal pile leachates, chemical landfill leachates, and the like.

It has been found that the use of a polyethyelene oxide (PEO) as a flocculant can be effective for the removal of phenols, halo phenols generally, fluorophenol and polyfluorophenol substances, even though these have high water solubility. For wastewater leachates with significant phenol contributions, it has been surprisingly discovered that flocculants consisting essentially of high molecular weight (>500,000 g/mole) polyethylene oxide can be effective to remove phenols, even without the use of an aromatic polymer cofactor. As used herein, flocculant polymers have average molecular weights of at least about 250,000 g/mole, and cofactor aromatic polymers are not considered themselves to be flocculant polymers. The flocculation process was also found to be very effective at removal of zinc contaminants, which suggest potential removal of other metals also. Suspended solids are also problematic for leachates and other water quality issues. The PEO flocculants are found to provide moderate removal of suspended solids in a very cost-effective process. The fact that phenols and zinc are removed more completely than the suspended solids suggests different sequestering mechanism, and that observation is surprising. While not wanting to be limited by theory, the phenol wastewater contaminants seem to act as a cofactor in the flocculation process. For some application, the solid particulate concentration of the wastewater is less than 1 weight % and in some embodiments less than 0.1 wt %, and the particulates can be fine as well as non-volatile dissolved organics. A person of ordinary skill in the art will recognize that additional ranges of solid particulate concentration within the explicit range above are contemplated and are within the present disclosure.

The surprising result that polyethylene oxide flocculation is effective for removal of phenols, indicates that this treatment process would be useful for treating specific wastewater with known phenol contaminants. As exemplified herein, this can involve landfill leachates with phenols and other particular sources of phenol contaminants, but chemical plant effluents with phenols can be a good target for this processing to remove phenols from the waste flow.

Polyethylene oxide is typically supplied commercially as a fine free flowing powder used for the manufacture of a number of different pharmaceutical and personal care applications. Commercially, there are a few various grades of polyethylene oxide particle sizes available to end users. Polyethylene glycol (PEG), polyethylene oxide (PEO), or poly(oxyethylene) (POE) refers to an oligomer or polymer of ethylene oxide. The three names are chemically synonymous, but historically PEG has tended to refer to oligomers and polymers with a molecular mass below 20,000 g/mol, PEO to polymers with a molecular mass above 20,000 g/mol, and POE to a polymer of any molecular mass. PEG compositions can be liquids or low melting solids, depending on the molecular weights of the polymer. PEG 400 generally refers to a PEG formulation with an average molecular weight between 380 g/mole and 420 g/mole. PEG 400 is commercially available, for example, as Dow CARBOWAX™ PEG 400. PEG 600 generally refers to a PEG formulation with an average molecular weight between 570 g/mole and 630 g/mole. Above a molecular weight of roughly 800 g/mole, PEG can be a waxy paste like material at room temperature.

Polyethylene oxide can be represented by the formula H—(O—CH₂—CH₂)ₙ—OH, where n refers to the degree of polymerization, and for high molecular weight polymers, n is large. The nature of the polymer can be characterized by the average molecular weight and suitable polymers can be linear or branched. In some flocculation embodiments, the average molecular weight of the polyethylene oxide can be at least about 500,000 g/mol, in further embodiments at least about 1 million g/mol, in other embodiments from about 2 million g/mol to about 22 million g/mol, in other embodiments from about 3 million g/mol to about 15 million g/mol, and in additional embodiments from about 4 million g/mol to 12 million g/mol. A person of ordinary skill in the art will recognize that additional ranges of polyethylene oxide (PEO) molecular weight within the explicit ranges above are contemplated and are within the present disclosure. Suitable commercial high molecular weight polyethyelene oxides are available from Dow Chemical, for example, Polyox WSR™ 308 or UCARFLOC™ 309, 304, etc. Particles of high molecular weight PEO in commercial distribution generally have an average particle diameter of roughly 150 microns, and the particle may be sieved to reduce the presence of small particles, such as particles with a diameter less than about 75 microns. In some embodiments, smaller particle sizes can be used.

Flocculation has been used in the context of removal of colloidal particles from contaminated water. Thus, flocculation has been used for removal of clays, similar colloidal minerals, and other colloidal particulates from mine tailings and other wastewater undergoing treatment. The present work involves the discovery that polyethylene oxide particles suitable for flocculation can also be effective in the removal of some dissolved organic contaminants. This discovery provides a convenient and cost-effective tool for removal of prevalent and dangerous contaminants with low capital investment. In particular, polyethylene oxide compounds in modest amounts have been found to be very effective at removal of phenolic contaminants dissolved in wastewater. In addition, polyethylene oxide has been found to be moderately effective in reducing total suspended solids, which may or may not be colloidal in nature, and somewhat effective in reducing amounts of nitrogen containing organics. The polyethylene oxide treatment was also found to be effective to remove a significant fraction of zinc, which was observed to be removed at a greater rate than the suspended solids. Likely other metals are similarly removed.

Polyethylene oxide (PEO) with cofactors have been used in papermaking. See, for example, Canadian patent application 2,194,205A1 to Brown et al., entitled “Process for Making a Paper Product,” incorporated herein by reference. In the papermaking process, the cofactor is added prior to the non-ionic polymer. Suitable cofactors for the paper making process include, for example, water soluble aromatic condensation resins, such as the product of an aldehyde, such as formaldehyde, and an aromatic compound such as phenol, a phenol-sulphone, napthalene, or the like. For flocculating particulate solids from paper mill waste, similar PEO plus cofactor systems can be used. See, U.S. Pat. No. 6,123,856 to Kampera et al., entitled “Dewatering of Sludges,” incorporated herein by reference. In the methods of Kampera et al., phenolic materials are used with PEO. As with paper pulping, the phenolic materials, phenolic resin, are generally added first in the methods of Kampera et al.

PEO combined with sulfonated aromatic polymers have also been used for water retention for aggregates of particles such as for disposal in the soil. The application of PEO for water retention is described in published U.S. patent application 2018/0195001A1 to Yu et al., entitled “Sequential Treatment With Aqueous Sulfonated Aromatic Polymer and Aqueous polyethylene Oxide for Enhanced Water Retention,” incorporated herein by reference. These systems can be used to help retain water in dry soils. The sulfonated aromatic polymers of Yu et al, overlap with the cofactors of Brown et al., above. As with the cofactors of papermaking processing, the sulfonated aromatic polymers for water retention are added prior to the PEO. According to Brown et al., this process order is required, see paragraph [0028]. In general, the cofactors/initiators are aromatic polymers. Paper forming cofactors are commercially available, such as OXIREZ from BASF Mining Solutions (formerly from Ciba Specialty Chemicals), which is a liquid phenyl sulfone resin.

It has been surprising found that PEO alone has been very effective at removal of soluble phenol contaminants from wastewater. Results suggest that there is a synergistic effect where the phenol contaminants generally facilitate the flocculation process, perhaps effectively as a cofactor, while they are removed. Nevertheless, the PEO has been found to be a very efficient and cost effective pre-treatment of landfill leachates, and these results indicate that other phenol containing wastewater can also be effectively treated with PEO flocculants to form flocs. In some embodiments, even though the PEO has been effective at the removal of phenols and other contaminants when delivered alone, an aromatic polymer, as a cofactor, can also be added to further improve the contaminant removal process. Furthermore, aromatic polymers can also be added as cofactors for wastewater cleanup for situations with less or effectively no phenolic contaminants to act as cofactors.

The PEO generally can be added to the wastewater in dry powder form, an aqueous solution or a suspension in an alcohol or polyalcohol. As described above, commercial supplies of PEO are generally in dry particulate form. While dry PEO can be directly added to the wastewater, this is a less desirable approach from a handling and metering perspective. PEO is soluble in water, and the PEO can be delivered from an aqueous solution at a selected concentration. In some embodiments, the aqueous PEO solution can have a polymer concentration from about 0.01 wt % to about 50 wt %, in further embodiments from about 0.05 wt % to about 40 wt % and in other embodiments form about 0.1 wt % to about 30 wt %. In general, the concentration is not particularly important as long as the solution is not too viscous for handling as long as the dosing is at desired levels. A person of ordinary skill in the art will recognize that additional ranges of polymer concentrations within the explicit range above are contemplated and re within the present disclosure.

PEO can also be delivered in particle suspensions, for example, in polyethylene glycol liquids. In corresponding embodiments, a flocculant polymer suspension comprises solid and liquid components. In particular, with respect to solid components, the suspensions generally can comprise from about 0.1 weight percent to about 60 weight percent flocculant polymer particles, in further embodiments from about 0.5 weight percent to about 55 weight percent, and in additional embodiments from about 1 weight percent to about 50 weight percent flocculant polymer particles. The liquid of the suspension generally comprises a liquid polyether polyol, e.g., diol or triol, with oxyethylene repeat units along the polymer backbone, which generally have moderate molecular weights, such as polyethylene glycol (PEG, HO—(CH₂—CH₂—O—)ₙH), propylene glycol (PPG, HO—(CH₂—CHCH₃—O—)ₙH), copolymers thereof or a mixture thereof (PEG/PPG) as the primary component or only component. PEG and PPG are ethers with two terminal hydroxyl groups and can be moderately viscous compositions, which influences the viscosity of the suspension. Glyceryl ether polymers are commercial polymers with PEG or PPG reacted with a glycerine molecule to form an ether linkage with the resulting molecule having three terminal hydroxyl groups. (Dow®, PT-series of polymers). Specifically, the liquid of the suspension can comprise at least about 75 weight percent, in further embodiments at least about 80 weight percent and in additional embodiments at least about 90 weight percent PEG/PPG. Polymers generally have a distribution of molecular weights, and the PEG generally has an average molecular weight from about 200 g/mole to about 700 g/mole and in further embodiments from about 300 g/mole to about 650 g/mole. PEG 400 (average molecular weight 380-420), PEG 600 (average molecular weight 580-620) and mixtures thereof can be effectively used. Polypropylene glycols can have suitable viscosities at average molecular weights in the several thousands, and are commercially available, for example, from Dow Chemical. Glyceryl ether polymers with three terminal hydroxyl groups are similarly commercially available with similar viscosities and other properties. Also, copolymers ethylene oxide and propylene oxide are commercially available. The liquid can be selected to not significantly dissolve the polymer particles. While the suspensions can consist essentially of flocculant polymer particles and liquid polyether glycol, e.g., PEG/PPG, other minor components can be included in the suspension if desired to modify the properties of the suspension, such as coloring agents, viscosity modifiers, surfactants, or the like, generally in amounts of no more than about 5 weight percent each. Suspensions of PEO in polyether polyols are described further in U.S. Pat. No. 9,714,342 to Holt et al., entitled “Particle Suspensions of Flocculating Polymer Powers,” incorporated herein by reference. Corresponding stable suspensions that generally do not settle are described in U.S. Pat. No. 9,908,976 to Holt, entitled “Stable Polyethylene Glycol Particle Dispersions and Methods for Forming the Stable Dispersions,” incorporated herein by reference.

In general, for leachate treatment, the PEO can be delivered at dosing levels relative to the amount of wastewater treated of about 0.01 ppm by weight to about 75 ppm by weight, in further embodiments from about 0.05 ppm to about 60 ppm, in other embodiments from about 0.1 ppm to about 50 ppm, and in additional embodiments form about 0.2 ppm to about 45 ppm. These values are referenced as the weight of added PEO divided by the weight of wastewater and then converted to parts per million reference. Generally, the desired amount of PEO depends on the molecular weight of the PEO with some expectation of lower amounts of a higher molecular weight generally used for comparable flocculation results, and on the amount and nature of the contaminants. A person of ordinary skill in the art will recognize that additional ranges of PEO dosing within the explicit ranges above are contemplated and are within the present disclosure.

In additional or alternative embodiments, the flocculation (such as a leachate pre-treatment) for water purification can be performed with a cofactor, generally an aromatic polymer. For embodiments using a cofactor, the cofactor can be added in a dose from about 0.05 ppm to about 250 ppm, in further embodiments from about 0.1 ppm to about 125 ppm, and in other embodiments from about 0.2 ppm to about 75 ppm by weight. Expressing the cofactor dosing in an alternative way, the weight ratio of cofactor to PEO (wt aromatic polymer/weight PEO) can be from, about 0.1 to 10, and in further embodiments form about 0.25 to about 7.5. In some embodiments, the aromatic polymers have a molecular weight from about 700 g/mole to about 500,000 g/mole and in further embodiments from about 1000 g/mole to about 250,000 g/mole. The amount of cofactor/initiator can be selected based on particular cofactor composition, the PEO flocculant composition and amount and the composition of the wastewater being purified. A person of ordinary skill in the art will recognize that additional ranges of cofactor dosing, weight ratios, and molecular weights within the explicit ranges above are contemplated and are within the present disclosure. A person of ordinary skill in the art will recognize that additional ranges of within the explicit ranges above are contemplated and are within the present disclosure.

In general, wastewater for processing can be collected from various suitable locations, and landfill leachate, coal pile leachate, leachate from chemical storage facilities or chemical landfill leachate are some sources of wastewater of particular interest. The collected leachate or other wastewater source can be delivered in sewage pipe, although other fluid conduits can be used, such as open channels can be used. If desired, a static mixer can be incorporated into the system to facilitate mixing of flocculant polymers with the wastewater. Flocs generated from the PEO addition can be separated from the wastewater to form a clean water flow using various modalities. Suitable modalities include, for example, filtering or screening, centrifugation, dissolved air floatation, a screen press or the like, or settling. Commercial centrifugation systems are available for continuous wastewater treatment, such as decanter centrifuges from Flottweg Separation Technology (Kentucky, USA). Dissolved air floatation systems for wastewater treatment are available from Komline-Sanderson (New Jersey, USA). Settling tanks can be relatively straightforward where the flocs settle to the tank bottom for removal and clarified water is separated from the top portion of the tank, such as the top third of the tank volume. Various screen and filtration technology is available commercially or a wide range of complexity, for example, Raptor® screen system for wastewater is available from Lakeside Equipment Corporation (Illinois, USA).

Depending on the configuration of the flow into the separation system and the type of separation equipment or separator used, the flocculant and/or cofactor can be added at appropriate points in the flow of the wastewater. For example, for embodiments without the use of a cofactor and with separation with a settling tank, the PEO could be metered directly into the settling tank. But generally the flocculant is administered into the flow some distance prior to the separator to provide for formation of flocs prior to the wastewater reaching the separator. If a cofactor (aromatic polymer) is used, the cofactor generally can be added prior to, with or after the PEO is added. But good results have been obtained for leachate treatment with the cofactor added after the PEO, which is a surprising result when considering cofactor use with paper making processes. In some embodiments, the PEO is added between the separator and about 100 feet from the separator, in further embodiments, from about 5 feet from the separator to about 80 feet from the separator, and in additional embodiments from about 8 feet to about 70 feet form the separator. A wide range of commercial metered dispensers are available for dispensing the PEO. In some embodiments, the cofactor is added to the flow from about 3 feet to about 60 feet downstream from the PEO addition, in further embodiments from about 4 feet to about 50 feet, and in other embodiment form about 5 feet to about 45 feet downstream from the PEO addition. A person of ordinary skill in the art will recognize that additional ranges of distances for addition of PEO and/or cofactor within the explicit ranges above are contemplated and are within the present disclosure.

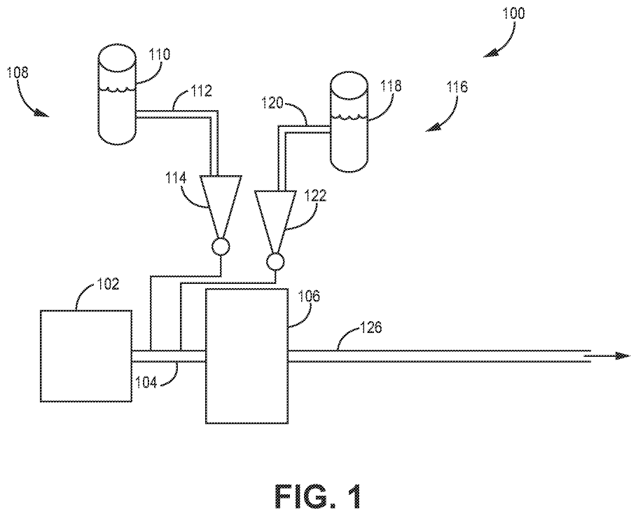

A schematic layout of a wastewater treatment facility at a landfill is presented in FIG. 1.

FIG. 1 is a schematic diagram of system 100 for treating wastewater. Untreated wastewater from a source 102, such as a landfill runoff collection system, chemical plant wastewater system or other source, flows as a raw, treatable wastewater through a channel 104. Wastewater treatment system 100 includes PEO delivery system 108 used to dispense or deliver an amount of PEO generally to channel 104, although in additional or alternative embodiments to separation system 106. Source 102 may include, for example, a runoff collection system including a leachate drainage conduit. Intake system 102 may include equipment used to pre-screen the source wastewater so as to carry away solid matter too large to be treatable once in the reservoir. In general, the PEO delivery system may comprise any means suitable for delivering PEO to the wastewater. In some embodiments, PEO may be delivered as a powder, and in some embodiments, PEO may be delivered in the form of a solution or suspension. PEO delivery system 108 comprises PEO reservoir 110 for storing or holding the POE for delivery to wastewater treatment system 100. Generally, PEO delivery system 108 comprises a conduit 112 configured to direct PEO to a metered delivery device 114. In some embodiments, delivery device 114 is designed and configured to deliver a steady stream of the PEO solution or suspension to the wastewater. In some embodiments, delivery device 114 is designed and configured to deliver specific amounts of the PEO, such as a powder, solution or suspension. For example, specific amounts of the PEO may be delivered according to time, or according to the amount of wastewater entering, passing through the system. For another example, the amount of PEO delivered by PEO delivery device 114 may be manually or automatically adjusted according to the level of contamination of the wastewater. The level of contamination may be assessed qualitatively, such as by color or turbidity as seen by the naked eye, or quantitatively using instrumentation. A wide variety of commercial metering systems are available for PEO delivery.

In some embodiments, wastewater treatment system 100 comprises a cofactor delivery system 116 used to dispense or deliver an amount of cofactor to the wastewater process flow, generally to conduit 104. In general, the delivery system may comprise any means necessary for delivering cofactor to wastewater treatment. In some embodiments, the cofactor may be delivered in a suitable form, such as a powder, a solution or suspension. Cofactor delivery system 116 generally comprises a cofactor reservoir 118 for storing or holding the cofactor for delivery to the wastewater process, generally in conduit 104, although in some embodiment alternatively or additionally to separation system 106.

Cofactor delivery system 108 comprises cofactor conduit 120 in fluid connection with cofactor reservoir 118 and with cofactor delivery device 122. Delivery device 122 delivers the cofactor to the wastewater treatment flow, generally into conduit 104. In some embodiments, cofactor is delivered into the wastewater treatment flow downstream from PEO delivery, although in alternative embodiments, cofactor can be delivered upstream at the same point of PEO delivery and/or directly into separation system 106. In some embodiments, delivery device 122 is designed and configured to deliver specific amounts of the cofactor. For example, specific amounts of the cofactor may be delivered according to time, or according to the amount of wastewater passing through the wastewater treatment system. For another example, the amount of cofactor delivered by cofactor delivery device 122 may be manually or automatically adjusted according to the amount of PEO being added to the wastewater.

Separation system 106 may comprise any equipment or separator suitable for separating flocculants from the wastewater and may be selected depending on the type of flocculants being removed. For example, separation system 106 may comprise equipment for centrifuging the flocculants. Separation system 106 may also comprise equipment for screening out the flocculants, for example, a single screen or a series of screens with a descending mesh sizes. Separation system 106 may comprise a combination of these aforementioned mechanical components.

The flocculation processes described herein have been found to be very effective for the removal of phenolic contaminants. Generally, volatile and semi-volatile phenolic contaminants can be reduced by at least about 60%, in some embodiments by at least about 70% and in further embodiments at least about 80% relative to initial values. Phenolic compounds can be evaluated using gas chromatography-mass spectrometry. Phenolic compounds can be reduced to amounts below about 250 micrograms per liter (μg/L). Zinc levels can be reduced by at least about 50%, in further embodiments at least about 75% and in further embodiments at least about 90% relative to initial values. Zinc may be reduced to values of less than 0.25 mg/L. Total suspended solids can be rejected by at least about 15%, in some embodiments at least about 25%, and in additional embodiments at least about 35% relative to initial values. Total suspended solids can be reduced to values of no more than 500 mg/L. Total Kjeldahl Nitrogen measurements of nitrogen containing contaminants can see reductions of more than 5% and in some embodiments about 6 to 10% relative to initial values. A person of ordinary skill in the art will recognize that additional ranges of contaminant removal within the explicit ranges above are contemplated and are within the present disclosure.

### EXAMPLES

### Example 1—Removal of Suspended Solids from Coal Pile Leachate

This example demonstrates the ability to remove suspended solids form leachate obtained from a coal pile using polyethylene oxide and a cofactor.

Experiments were performed using OXIREZ (initiator) and PEO. The PEO was obtained from PSMG (Georgia, USA), and OXIREZ was obtained from BASF Mining Solutions. Visible purification of the water was ineffective until the OXIREZ was also added. Approximately 1000 mL of coal storage leachate was added to a 1500 mL beaker equipped with overhead mechanical stirring. The leachate had a yellow-brown hue and appeared significantly turbid. PEO (1 to 10 ppm) was added and the sample was stirred until the PEO dissolved. No significant visible change was observed.

One drop of OXIREZ was added and after stirring for several seconds, the color of the sample began to disappear and turbidity decreased. After about 15 seconds, the sample appeared colorless and was not turbid, and black particles or particulates of various sizes were observed. Once the OXIREZ was blended with the mixture, then clarified water was obtained. With respect to the initiators, the paper forming cofactors can also effective for flocculation of the coal storage leachate based on the experiments.

Good results are obtained with the first addition of the PEO followed by the addition of the initiator, which can be after the PEO is blended with the wastewater.

### Example 2—Analysis of Leachate from Landfill Located in Virginia

This example demonstrates the treatment of a leachate taken from a landfill and analyzed using methods provided by the U.S. Environmental Protection Agency (EPA).

Two samples were analyzed for chemical content. A Raw sample was collected from a leatchate collection system of the landfill and analyzed without further treatment except for addition of strong acids to adjust the pH, if described in an EPA method. A Treated sample was collected from the landfill at the same time and location and treated with PEO in 1000 ml beaker similar to Example 1 but with just PEO. After the flocs settled, the cleaned water was sampled form the upper portion of the beaker.

The following EPA methods were employed in the analysis: zinc metal using inductively coupled plasma-atomic emission spectrometry according to Method 200.2, Revision 2.8 and Method 200.7, Revision 4.4; phenolic compounds using gas chromatography combined with mass spectrometry according to Method 625.1; and organic nitrogen and ammonia or Total Kjeldahl Nitrogen (TKN) as nitrogen according to Method 351.2, Revision 2.0. Total suspended solids was measured according to Standard Methods For the Examination of Water and Wastewater 2540D-2011, as published by the American Public Health Association.

Results are summarized in the Table.

TABLE

| | | | Change |
|---|---|---|---|
| Parameter | Raw | Treated | (% Decrease) |
| Zinc | 2.37 mg/L | 0.18 | 92 |
| Phenol | 2040 μg/L | <250 μg/L¹ | >88 |
| 2-Fluorobiphenyl | 20.0% | ND | 100 |
| 2-Fluorophenol | 14.0% | 1.00% | 93 |
| TKN as N | 1510 mg/L | 1380 mg/L | 9 |
| Total Suspended | 750 mg/L | 430 mg/L | 43 |
| Solids | | | |

ND = not detected
¹Reporting limit was 250 μg/L.

### Further Inventive Concepts

1. A method for performing the removal of unwanted solids and organics from leachate or runoff treatment streams comprising the introduction of a non-ionic water soluble polymer with a molecular weight of between 500,000 and 22 million and subsequently followed by an aromatic polymer or a phenolic solution to induce flocculation.
2. The method of further inventive concept 1 wherein the non-ionic polymer comprises polyethylene oxide.
3. The method of further inventive concept 1 wherein aromatic polymer is a polymer of phenol, formaldehyde, sulfonic acid monomers, a naphthalene-2-sulfonic acid resin, a vinyl phenol resin, a sulfonated draft lignin, or mixtures thereof.
4. The method of further inventive concept 1 wherein unwanted solids comprise suspended solids.
5. The method of further inventive concept 1 wherein the organics comprise polyfluoroalkyl substances.
6. The method of further inventive concept 1 wherein the organics comprise phenols.
7. The method of further inventive concept 1 wherein the leachate comprises coal storage pile leachate.
8. The method of further inventive concept 1 wherein the leachate comprises landfill leachate.
9. The method of further inventive concept 1 wherein the non-ionic flocculant and aromatic polymer are added to a flow of the leachate.
10. The method of further inventive concept 1 wherein the non-ionic flocculant polymer is added in an amount form about 0.01 ppm by weight to about 100 ppm by weight and wherein the aromatic polymer is added in a quantity from about 0.05 ppm to about 250 ppm by weight.
11. The method of further inventive concept 1 further comprising separating the flocculated solids from the leachate solution to reduce contaminants from the leachate stream and to form a cleaned water flow.
12. The method of further inventive concept 11 wherein the flow with the flocs is directed to a screen to collect the flocs, to a settling tank or reservoir, to a centrifuge, to a dissolved air floatation unit, to a screen press, or to a filtration system where the separating step is performed.
13. The method of further inventive concept 1 wherein unwanted solids being solubilized organics from mineral processing streams.
14. The method of further inventive concept 1 wherein flocculated solids are separated from said treatment stream by land application.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to the understanding of a person of ordinary skill in the art in the particular context, which may involve measurement error and/or reporting precision as would be understood by a person of ordinary skill in the art in the context for the particular parameter unless explicitly indicated otherwise.

What is claimed is:

1. A method for the removal of contaminants from landfill leachate, the method comprising:
adding polyethylene oxide to landfill leachate to form flocs, wherein the polyethylene oxide has an average molecular weight of at least 500,000 g/mole; and
separating the flocculated solids from the leachate solution to reduce contaminants from the leachate stream to form a treated water stream.

2. The method of claim 1 wherein the polyethylene oxide is dissolved in water prior to adding to the leachate.

3. The method of claim 1 wherein the polyethylene oxide is suspended in a liquid polyalcohol prior to adding to the leachate.

4. The method of claim 1 wherein the polyethylene oxide is added at a concentration from about 0.01 ppm by weight to about 100 ppm by weight.

5. The method of claim 1 wherein the adding of the polyethylene oxide is performed in a flow conduit to form flocs in the flow.

6. The method of claim 5 wherein the flow with the flocs is directed to a separation system to collect the flocs, wherein the separation system comprises a screen, a settling tank, dissolved air floatation unit, or reservoir, a centrifuge, screen press, or a filtration system, where the separating step is performed.

7. The method of claim 1 wherein the adding of the polyethylene oxide is performed into a tank or reservoir holding leachate, and wherein the separating step is performed by settling the flocs or filtering the flocs.

8. The method of claim 1 wherein phenolic compounds in the treated water stream are no more than about 0.5 times the amount of phenolic compounds in the leachate.

9. The method of claim 1 wherein phenolic compounds in the treated water stream are no more than about 0.2 times the amount of phenolic compounds in the leachate and suspended solids in the treated waste stream are no more than 80% of the amount of suspended solids in the leachate.

10. The method of claim 1 wherein the polyethylene oxide has a molecular weight from about 2 million g/mole to about 22 million g/mole.

11. The method of claim 1 wherein the amount of zinc in the treated waste stream is no more than about 75% of the amount of zinc in the leachate, suspended solids in the treated waste stream are no more than 90% of the amount of suspended solids in the leachate, and the amount of Total Kjeldahl Nitrogen in the treated waste stream is no more than about 90% of the Total Kendahl Nitrogen in the leachate.

12. The method of claim 1 further comprising adding an aromatic polymer to the leachate to facilitate floc formation.

13. A system for purification of landfill leachate comprising:
a landfill comprising a runoff collection system comprising a leachate drainage conduit;
a separation system;
a polyethylene oxide (PEO) delivery system comprising a PEO reservoir and an outflow conduit;
an inflow channel configured to deliver landfill leachate to the separation system; and
an outflow to allow purified water to exit from the separation system,
wherein the outflow conduit of the PEO delivery system is configured to add PEO to the leachate stream prior to introduction into the separation system.

14. The system of claim 13 wherein the separation system comprises a settling tank, filter, dissolved air floatation unit, screen press, or centrifuge.

15. A method for removal of phenols from wastewater, the method comprising:
adding polyethylene oxide to wastewater that has been determined to have an undesirably high phenol contaminant level, wherein the polyethylene oxide has an average molecular weight of at least 500,000 g/mole and wherein the polyethylene oxide forms flocs sequestering the phenol that is reduced to levels in the water to no more than 500 μg/liter.

16. The method of claim 15 wherein the polyethylene oxide is dissolved in water prior to adding to the wastewater.

17. The method of claim 15 wherein the polyethylene oxide is suspended in a liquid polyalcohol prior to adding to the wastewater.

18. The method of claim 15 wherein the polyethylene oxide is added at a concentration from about 0.01 ppm by weight to about 100 ppm by weight.

19. The method of claim 15 wherein the adding of the polyethylene oxide is performed in a flow conduit to form flocs in the flow.

20. The method of claim 19 further comprising separating the flocculated solids from the leachate solution to reduce contaminants from the leachate stream to form a treated water stream and wherein the flow with the flocs is directed to a separation system to collect the flocs, wherein the separation system comprises a screen, a settling tank, dissolved air floatation unit, or reservoir, a centrifuge, screen press, or a filtration system, where the separating step is performed.

21. The method of claim 15 wherein the adding of the polyethylene oxide is performed into a tank or reservoir holding wastewater, and wherein the separating step is performed by settling the flocs or filtering the flocs.

22. The method of claim 15 wherein suspended solids in the treated waste stream are no more than 80% of the amount of suspended solids in the wastewater.

23. The method of claim 15 wherein the polyethylene oxide has a molecular weight from about 2 million g/mole to about 22 million g/mole.

24. The method of claim 15 wherein phenolic compounds in the treated water stream are no more than about 0.2 times the amount of phenolic compounds in the wastewater, the amount of zinc in the treated waste stream is no more than about 75% of the amount of zinc in the wastewater, suspended solids in the treated waste stream are no more than 90% of the amount of suspended solids in the wastewater, and the amount of Total Kjeldahl Nitrogen in the treated waste stream is no more than about 90% of the Total Kjeldahl Nitrogen in the wastewater.
